(19) United States
(12) Patent Application Publication
(10) Pub. No.: US 2013/0225121 A1
(43) Pub. Date: Aug. 29, 2013

(54) Method and Apparatus to a Driver's Interaction with a Wireless Transceiver

(71) Applicant: RESEARCH IN MOTION LIMITED, (US)

(72) Inventors: Philip Gabriel YURKONIS, Campbell, CA (US); Robert Felice MORI, Palo Alto, CA (US)

(73) Assignee: RESEARCH IN MOTION LIMITED, Waterloo (CA)

(21) Appl. No.: 13/779,911

(22) Filed: Feb. 28, 2013

Related U.S. Application Data
(60) Provisional application No. 61/604,790, filed on Feb. 29, 2012.

(51) Int. Cl. H04W 8/18

(52) U.S. Cl. CPC H04W 8/18
USPC 455/405

(57) ABSTRACT

A control circuit determines when a user of the corresponding apparatus is presently driving a vehicle and then, in response to detecting this use state, monitors the user's interaction with the apparatus while driving the vehicle to provide corresponding usage data. The control circuit then provides this usage data to a remote service.

### FIELD OF TECHNOLOGY

The present disclosure relates to portable electronic devices and in particular to portable wireless two-way communications devices.

### BACKGROUND

Electronic devices, including portable electronic devices, have gained widespread use and may provide a variety of functions including, for example, telephonic, electronic messaging and other personal information manager (PIM) application functions. Portable electronic devices include portable wireless communication devices including several types of mobile stations such as simple cellular telephones, so-called smart telephones, wireless personal digital assistants (PDAs), and laptop computers with wireless 802.11 or Bluetooth capabilities.

At least some of the foregoing functionality often relies, in whole or in part, on a visually-based user interface such as a display, a keyboard, a touch-screen display, and so forth. In many cases the user of such a device must devote, at least temporarily and intermittently, some amount of their available cognitive abilities to properly interacting with such a visually-based user interface in order to fully exploit such functionality. At least in some application settings, and for at least some users, there may be circumstances that mitigate against multitasking such activities with other possibly higher-priority tasks such as driving a vehicle in challenging circumstances.

Corresponding improvements in two-way wireless communications devices are desirable.

### BRIEF DESCRIPTION OF THE DRAWINGS

FIG. 1 is a block diagram in accordance with the disclosure.

FIG. 2 is a perspective view in accordance with the disclosure.

FIG. 3 is a flow diagram in accordance with the disclosure.

FIG. 4 is a block diagram in accordance with the disclosure.

### DETAILED DESCRIPTION

The following describes an apparatus and method pertaining to a control circuit that determines when a user of the corresponding apparatus is presently driving a vehicle and then, in response to detecting this use state, monitor the user's interaction with the apparatus while driving the vehicle to provide corresponding usage data. The control circuit then provides this usage data to a remote service.

By one approach the control circuit can determine whether the user is presently driving a vehicle by relying upon a direct acknowledgement of the user and/or by indirect means.

The monitored user interaction can comprise, for example, monitoring the user's interaction with a visually-based user interface and/or a wireless transceiver as comprise parts of the apparatus that includes the control circuit. These teachings will generally accommodate, however, monitoring essentially any indicator of a user interaction while driving.

The provision of the usage data to a remote service can occur as frequently or as infrequently as may be desired to suit the needs of a given application setting. This provisioning can include, for example, pushing the usage data on a real-time or near-real-time basis to the remote service. As another example, this provisioning can comprise batching the usage data and providing the batched usage data pursuant to some schedule (such as, for example, once a day at a particular time). As yet another example, this provisioning can comprise providing the usage data to the remote service when a corresponding inquiry arrives from, or on behalf of, the remote service.

These teachings will also accommodate a variety of remote services. By one approach, for example, the remote service can comprise a social-networking service such as Facebook, Google+, Twitter, and so forth. Using this approach, part or all of the usage data can be posted, processed, and/or pushed to make the usage information directly or indirectly available to others within the social network of the user. So configured, these teachings can facilitate social leveraging to aid the user in practicing one or more usage behaviors as regards their personal communications devices while driving.

These teachings are highly flexible in practice and will accommodate a wide variety of driving detection methodologies, monitoring possibilities, and remote services. The approaches described herein are also scalable and will accommodate deployment over as small or as large a user population as may be desired.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

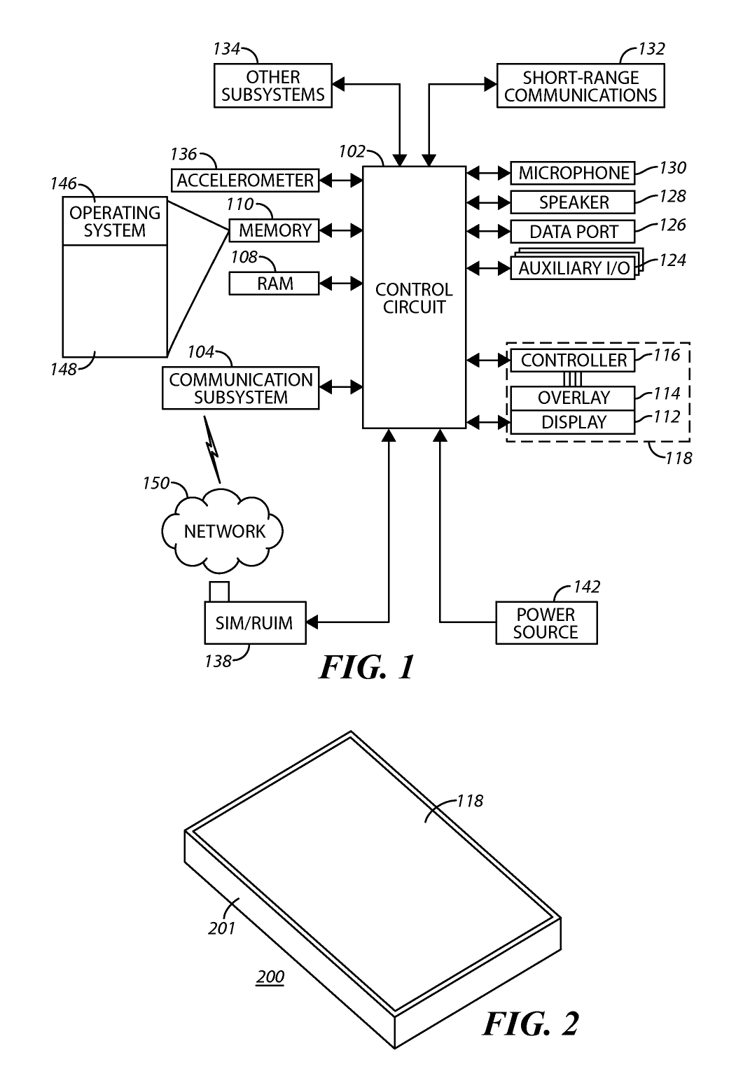

Referring to FIG. 1, an example portable electronic device includes a control circuit 102 (such as a properly programmed processor) that controls the overall operation of the portable electronic device. Communication functions, including data and voice communications, are performed through a communication subsystem 104. The communication subsystem receives messages from and sends messages to a wireless network 150. The wireless network 150 may be any type of wireless network, including, but not limited to, data wireless networks, voice wireless networks, and networks that support both voice and data communications. A power source 142, such as one or more rechargeable batteries or a port to an external power supply, powers the portable electronic device.

The control circuit 102 interacts with other elements, such as a Random Access Memory (RAM) 108, a memory 110, a display 112 with a touch-sensitive overlay 114 operably coupled to an electronic controller 116 that together comprise an optional touch-sensitive display 118 (sometimes referred to herein as a touch-screen display), an auxiliary input/output (I/O) subsystem 124 (which might comprise, for example, a physical keyboard such as a full QWERTY keyboard), a data port 126, a speaker 128, a microphone 130, a short-range communication subsystem 132 (such as, for example, a Bluetooth-based short-range communication subsystem), and other device subsystems 134 of choice.

One or more user interfaces are provided. Input via a graphical user interface is provided via the touch-sensitive overlay 114. The control circuit 102 interacts with the touch-sensitive overlay 114 via the electronic controller 116. Information, such as text, characters, symbols, images, icons, and other items that may be displayed or rendered on a portable electronic device, is displayed on the touch-sensitive display 118 via the control circuit 102.

The control circuit 102 may interact with an accelerometer 136 that may be utilized to detect direction of gravitational forces or gravity-induced reaction forces that may be associated, for example, with the physical dynamics of driving a vehicle.

To identify a subscriber for network access, the portable electronic device may utilize a Subscriber Identity Module or a Removable User Identity Module (SIM/RUIM) card 138 for communication with a network, such as the wireless network 150. Alternatively, user identification information may be programmed into the memory 110.

The portable electronic device includes an operating system 146 and software programs, applications, or components 148 that are executed by the control circuit 102 and are typically stored in a persistent, updatable store such as the memory 110. Additional applications or programs may be loaded onto the portable electronic device through the wireless network 150, the auxiliary I/O subsystem 124, the data port 126, the short-range communications subsystem 132 (such as, for example, a Bluetooth-compatible transceiver), or any other suitable subsystem 134 (such as, for example, a global positioning system (GPS) receiver). The memory 110 may comprise a non-transitory storage media that stores executable code that, when executed, causes the control circuit 102 to carry out one or more of the functions or actions described herein.

A received signal such as a text message, an e-mail message, or web page download is processed by the communication subsystem and input to the control circuit 102. The control circuit 102 processes the received signal for output to the display 112 and/or to the auxiliary I/O subsystem 124. A subscriber may generate data items, for example e-mail messages, that may be transmitted over the wireless network 150 through the communication subsystem. For voice communications, the overall operation of the portable electronic device is similar. The speaker 128 outputs audible information converted from electrical signals and the microphone 130 converts audible information into electrical signals for processing.

The touch-sensitive display 118 may be any suitable touch-sensitive display, such as a capacitive, resistive, infrared, surface acoustic wave (SAW) touch-sensitive display, strain gauge, optical imaging, dispersive signal technology, acoustic pulse recognition, and so forth, as known in the art. One or more touches, also known as touch contacts, touch events, or sometimes gestures may be detected by the touch-sensitive display 118. The control circuit 102 may determine attributes of the touch, including a location, direction, and/or extent of a touch. Touch location data may include data for an area of contact or data for a single point of contact, such as a point at or near a center of the area of contact.

Referring to FIG. 2, for the sake of illustration but without intending any limitations in these regards, the following description will presume that the portable electronic device comprises a portable two-way wireless communications device 200 such as a so-called smartphone. Such a device 200 often comprises a housing 201 to contain the foregoing components including the touch-screen display 118.

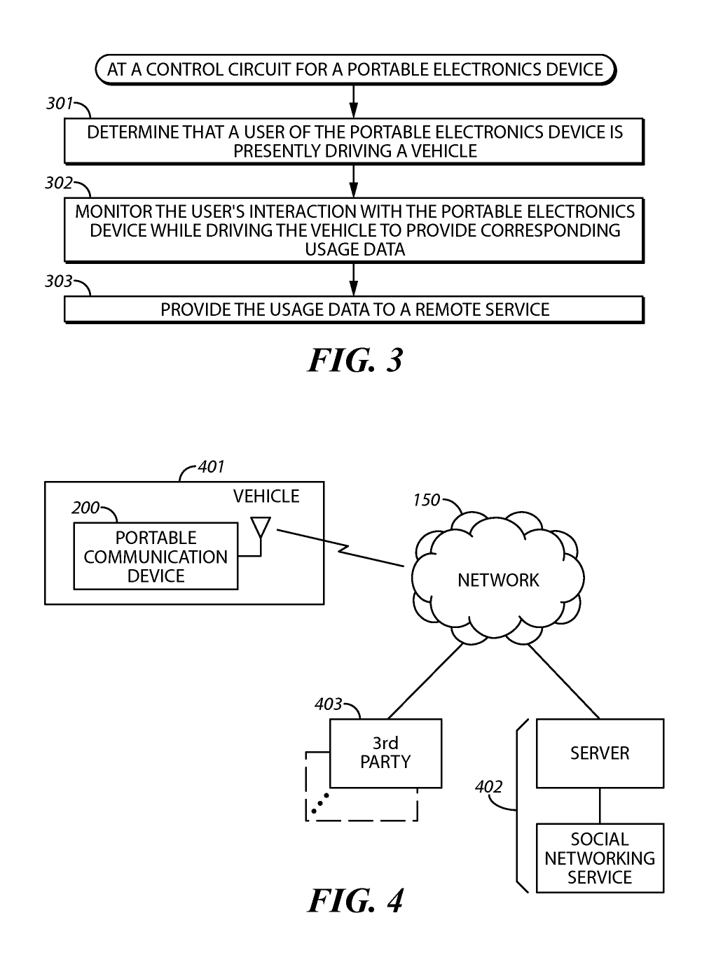

Referring to FIGS. 3 and 4, the control circuit 102 of the portable communication device 200 is configured to determine 301 that a user of the portable communication device 200 is presently driving a vehicle 401. By one approach this determination is based, at least in part, upon detecting (via, for example, a user interface) a direct acknowledgement from the user in these regards. This determination might comprise, for example, providing an icon/button on the device's touch-screen display 118 that the user asserts to directly acknowledge the driving user state.

By another approach this determination is based, at least in part, upon indirectly detecting that the user is presently driving a vehicle. Such an indirect determination can be based, for example, upon one or more sensed or received indicators of movement. As one example in these regards, the aforementioned accelerometer 136 can provide data to the control circuit 102 regarding sensed conditions that may correspond to movement of the portable communication device 200 in a vehicle 401.

As another example in these regards, the aforementioned global positioning system receiver 134 can provide data to the control circuit 102 to permit the control circuit 102 to detect movement that is likely attributable to a vehicle.

As yet another example in these regards, the control circuit 102 can communicate with the vehicle 401 (for example, to an on-board vehicular computer) via, for example, the aforementioned short range communications system 132. The control circuit 102 may then be able to glean information such as the speed of the vehicle, the present state of the vehicle's transmission, seat sensor information (indicating, for example, that the driver's seat is occupied), and so forth.

These teachings will support other possibilities as well. For example, in lieu of the foregoing or in combination therewith, one could detect the presence and/or location of the person in the driver's seat and/or passenger compartment using one or more microphones (embedded, for example, in the passenger compartment or in the device itself) along with, if desired, speaker-recognition approaches.

It is possible, of course, that even a relatively sophisticated approach to indirectly detecting that the user of the device 200 is presently driving may come to an inaccurate conclusion. If desired, detecting indicia of driving can serve to provide a prompt to the user (such as a visual, auditory, and/or haptic prompt) to now acknowledge their driving state. By one approach, the control circuit 102 is configured to only determine that the user is, in fact, driving if the user affirms positively to such a prompt. By another approach the control circuit 102 determines that the user is driving unless the driver affirmatively indicates otherwise. The present teachings will also accommodate a combination of these approaches where, for example, more definitive indicia of driving give rise to an opportunity for the user to indicate that they are not driving while other less-definitive indicia of driving might give rise to an opportunity for the user to indicate that they are driving.

When the control circuit 102 does determine that the user is presently driving a vehicle 401, the control circuit 102 monitors 302 the user's interaction with the portable electronics device while driving the vehicle 401 to provide corresponding usage data. Activities of interest might include, by way of example but without intending to suggest any limitations in these regards, scrolling a hierarchical list (such as a list of mp3 music files), opening, scrolling, or otherwise interacting with emails or text messages, Internet browsing, accessing and interacting with applications, and so forth. These teachings will accommodate a wide variety of possibilities in these regards, both individually and in various combinations and permutations.

As one example in these regards, this monitoring 302 can comprise monitoring the user's interaction with a visually-based user interface. By one approach this can comprise monitoring touch-based taps, swipes, and other gestures applied by the user to the touch-screen display 118. These teachings will accommodate treating some interactions (such as a simple, short tap on the touch-screen display 118 that is without apparent intent as to a specific touched location) as unimportant while treating other interactions (such a involved or multi-contact swipes or gestures, or taps that reflect an apparent intent regarding the touched location) as being important and hence tracked, logged, and/or counted.

Somewhat similarly, different counts can be maintained for differently categorized interaction events. Using this approach, for example, a count could be maintained for trivial events, another count could be maintained for short, uncomplicated events, and yet another count could be maintained for longer and/or intricate or involved interactions.

As another example, this monitoring 302 can comprise monitoring a user's interaction with a keyboard. Keyboards can include both virtual keyboards that are presented via the touch-screen keyboard 118 as well as physical keyboards that serve as an input component 124 for the apparatus.

As yet another example, this monitoring 302 can comprise monitoring a user's answering (or otherwise reacting to) an incoming call and/or initiating a call. Again, different interactions can be categorically differentiated from one another as desired to treat, for example, some keyboard interactions as being or greater, or lesser, concern than others.

The disclosed concept will accommodate other useful inputs in these regards as well. For example, steering corrections could be detected using device accelerometers, and verified via another approach. As another example in these regards, the device could monitor and learn ordinary driving patterns (using, for example, one or more accelerometers) and use detected deviations from such patterns to again detect or confirm behavior of interest.

It will be understood that the monitoring examples provided above are intended to serve an illustrative purpose and are not to be construed as comprising an exhaustive listing of all possible monitoring opportunities. In fact, these teachings are highly flexible in these regards and will accommodate a very wide variety of possibilities. As but one example in these regards, the specific interactions monitored and/or the categorization and tracking that occurs with respect to the monitored interactions can vary as function of the time of day, the day of the week, the driving location (urban versus rural, for example, the proximity of other traffic, the present speed of the vehicle, the age and/or driving experience of the driver, and so forth), weather conditions, the presence of other persons in the vehicle (detected, for example, via the vehicle's seat sensors), and so forth.

The control circuit 102 then provides 303 the usage data to a remote service 402. By one approach the usage data can be conveyed via an intervening wireless network or other network or networks 150 of choice. (As used herein, the expression “remote” will be understood to refer to a location that is both physical distant from the portable communication device 200 (such as in another city, state or territory, country, or even continent) and virtually removed (where, for example, the service 402 is sponsored by and/or operated by an enterprise that is legally distinct and separate from the portable communication device 200 and the user).)

This remote service 402 can comprise, for example, a social-networking service and the server(s) that facilitate that service. So configured, the social-networking service can gather such usage data and publish that information in whole or in part and processed as desired. This activity, in turn, will permit third parties 403 to view such information. (In a similar manner, the same usage information can be gathered from some or all of these third parties 403 and with, for example, the user of the portable communication device 200.)

The usage information can be shared as a simple set of metrics if desired. By another approach the usage information can be published in ways that encourage competition amongst those persons who contribute their usage information in this manner. Such a competition, in turn, can have the beneficial effect of encouraging the participants to exhibit and practice certain specified behaviors in order to achieve and post correspondingly favorable usage data. These desirable behaviors may, in time, become sufficiently practiced as to become second nature for the participating individuals.

So configured, a person can find themselves motivated and encouraged to develop good behaviors as regards the use of their portable communications devices while driving.

These teachings are also highly flexible in practice and will accommodate a considerable range of variation and modification. As one example in these regards, an insurance company (or insurance industry group or other concerned body) might operate or otherwise sponsor the aforementioned remote service 402 and offer discounts, rebates, or other financial benefits to persons who successfully evidence desired monitored behaviors.

The present disclosure may be embodied in other specific forms without departing from its essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

We claim:

1. An apparatus comprising:
a wireless transceiver;
a visually-based user interface;
a control circuit operably coupled to the wireless transceiver and the visually-based user interface and configured to:
determine that a user of the apparatus is presently driving a vehicle;
monitor the user's interaction with the apparatus while driving the vehicle to provide corresponding usage data;
provide the usage data to a remote service.

2. The apparatus of characterization 1 wherein the apparatus comprises a portable two-way communications device.

3. The apparatus of characterization 1 wherein monitoring the user's interaction with the apparatus comprises, at least in part, monitoring the user's interaction with the visually-based user interface.

4. The apparatus of characterization 3 wherein the visually-based user interface includes, at least in part, a keyboard.

5. The apparatus of characterization 1 wherein monitoring the user's interaction with the apparatus comprises, at least in part, monitoring the user's interaction with the wireless transceiver.

6. The apparatus of characterization 5 wherein monitoring the user's interaction with the wireless transceiver comprises at least one of monitoring the user answering a call and initiating a call.

7. The apparatus of characterization 1 wherein the control circuit is configured to determine that the user is presently driving a vehicle, at least in part, by detecting direct acknowledgement of driving a vehicle by the user.

8. The apparatus of characterization 1 wherein the control circuit is configured to determine that the user is presently driving a vehicle, at least in part, by indirectly detecting that the user is presently driving a vehicle.

9. The apparatus of characterization 1 wherein the remote service comprises a social-networking service.

10. A method comprising:
at a control circuit for a portable electronics device:
determining that a user of the portable electronics device is presently driving a vehicle;
monitoring the user's interaction with the portable electronics device while driving the vehicle to provide corresponding usage data;
providing the usage data to a remote service.

11. The method of characterization 10 wherein monitoring the user's interaction with the portable electronics device comprises, at least in part, monitoring the user's interaction with at least one of a visually-based user interface and a wireless transceiver.

12. The method of characterization 11 wherein monitoring the user's interaction with the wireless transceiver comprises monitoring at least one of answering a call and initiating a call.

13. The method of characterization 10 wherein the remote service comprises a social-networking service.

14. A non-transitory computer storage medium having instructions stored therein, which instructions, when executed by a processor, cause the processor to:
determine that a user of the processor is presently driving a vehicle;
monitor the user's interaction with the processor while driving the vehicle to provide corresponding usage data;
provide the usage data to a remote service.
